(19) United States
(12) Patent Application Publication
(10) Pub. No.: US 2007/0121312 A1
(43) Pub. Date: May 31, 2007

(54) Lighting device for display device used in vehicles

(75) Inventors: Dong Woo Kim, Seoul (KR); Bang Won Oh, Seongnam (KR); Tae Jun Kim, Pyeongtaek (KR); Su Yeol Lee, Seongnam (KR)

Correspondence Address: MCDERMOTT WILL & EMERY LLP, 600 13TH STREET, N.W., WASHINGTON, DC, 20005-3096, US

(73) Assignee: SAMSUNG Electro-Mechanics Co., Ltd.

(21) Appl. No.: 11/602,310

(22) Filed: Nov. 21, 2006

(30) Foreign Application Priority Data
Nov. 25, 2005 (KR) 10-2005-0113245

(51) Int. Cl. G01D 11/28

(52) U.S. Cl. 362/27; 362/231

(57) ABSTRACT

The present invention relates to a lighting device for display device used in vehicles, the light device including an indicator provided with a rotating shaft; a graphic plate disposed under the indicator and having a through hole formed in the center thereof, into which the rotating shaft is inserted; and an LED section that is disposed under the graphic plate, generates light onto the graphic plate, and is provided with LED chips having different colors.

### CROSS-REFERENCE TO RELATED APPLICATIONS

The application claims the benefit of Korea Patent Application No. 2005-113245 filed with the Korea Intellectual Property Office on Nov. 25, 2005, the disclosure of which is incorporated herein by reference.

### BACKGROUND OF THE INVENTION

1. Field of the Invention

The present invention relates to a lighting device for display device used in vehicles. The lighting device can be applied to parts (for example, a dash board, an audio, a display device and the like), which are mounted on various vehicles such as cars, trains, ships, airplanes, helicopters and motorcycles and have a lighting function.

2. Description of the Related Art

Among display devices used in various vehicles, a dashboard used in cars is representative. In the dashboard, a simple color or a unified color is applied in accordance with a type of car. Recently, as an applied field of a light emitting diode (LED) for lighting is widened, the adoption of the LED as a lamp of cars gradually increases. Accordingly, the car lamp market puts down roots as one of important LED markets. Further, an existing display unit installed inside cars, which has had only a simple information display function, is developing into a multi-function display unit.

FIG. 1 is a plan view illustrating a car dashboard which emits light using a general lighting device.

In the car dashboard which informs a driver of a traveling state of a car through the operation of an indicator 10 on a graphic plate 30, a direct lighting method is employed. In the direct lighting method, an incandescent lamp, a cold cathode tube, an electro luminescence plate, or an LED is used as a lighting source. Here, reference numeral 70 of FIG. 1 represents an external case.

However, since the scattering of emitted light is severe, the incandescent lamp has non-uniform lighting performance, and the lifespan thereof is short. In a case where the cold cathode tube or electro luminescence plate is used instead of the incandescent lamp, more bright and uniform lighting can be obtained than when the incandescent lamp is used. However, the structure thereof is more complicated, the cost thereof is more expensive than the incandescent lamp or LED, and the lifespan thereof is short like the incandescent lamp.

Conventionally, as an LED is used as a lighting source of a car dashboard or the like, a semi-permanent lifespan and a lighting source with high luminance are obtained.

FIG. 2 is a sectional view illustrating a conventional lighting device for display device used in vehicles, the light device using the LED.

As shown in FIG. 2, the conventional lighting device for display device includes an indicator 10 provided with a rotating shaft 20; a graphic plate 30 disposed under the indicator 10 and having a through hole formed in the center thereof, into which the rotating shaft 20 is inserted; an LED 40 disposed under the graphic plate 30; a reflecting section 50 which reflects light generated by the LED 40 onto the graphic plate 30; and a motor 60 which is disposed on the rear surface of the graphic plate 30 and is connected to the rotating shaft 20 of the indicator 10 in order to support and drive the indicator 10.

The conventional lighting device according to the related art is constructed so that light generated from the LED 40 fixed to the inside of the case 70 is directly illuminated onto the graphic plate 30. In this case, the LED 40 is composed of one-color LED, and the reflecting section 50 reflects light generated from the LED 40 onto the graphic plate 30, thereby enhancing a lighting effect of the LED 40.

In the above-described lighting device for display device, however, the LED 40 as a lighting source is composed of one-color LED. Therefore, the LED can implement only a simple color, but cannot implement various colors in accordance with a user's taste.

### SUMMARY OF THE INVENTION

An advantage of the present invention is that it provides a lighting device for display device used in vehicles, which is capable of implementing various colors in accordance with a user's taste by combining multiple colors of light.

Additional aspects and advantages of the present general inventive concept will be set forth in part in the description which follows and, in part, will be obvious from the description, or may be learned by practice of the general inventive concept.

According to an aspect of the invention, a lighting device for display device used in vehicles includes an indicator provided with a rotating shaft; a graphic plate disposed under the indicator and having a through hole formed in the center thereof, into which the rotating shaft is inserted; and an LED section that is disposed under the graphic plate, generates light onto the graphic plate, and is provided with LED chips having different colors.

According to another aspect of the invention, the LED section is composed of more than two combinations of a group consisting of a red LED chip, a green LED chip, and a blue LED chip.

According to a further aspect of the invention, the LED section is provided with at least one LED unit which is composed of a combination of more than two chips selected from a group consisting of a red LED chip, a green LED chip, and a blue LED chip.

According to a still further aspect of the invention, the lighting device for display device further includes a reflecting section that reflects the light, generated by the LED section, onto the graphic plate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view illustrating a dash board which emits light using a general lighting device;

FIG. 2 is a sectional view of a conventional lighting device for display device used in vehicles;

FIG. 3 is a sectional view of a lighting device for display device used in vehicles according to the present invention; and

FIGS. 4 and 5 are plan views illustrating LED arrangements of the lighting device for display device according to an embodiment of the invention.

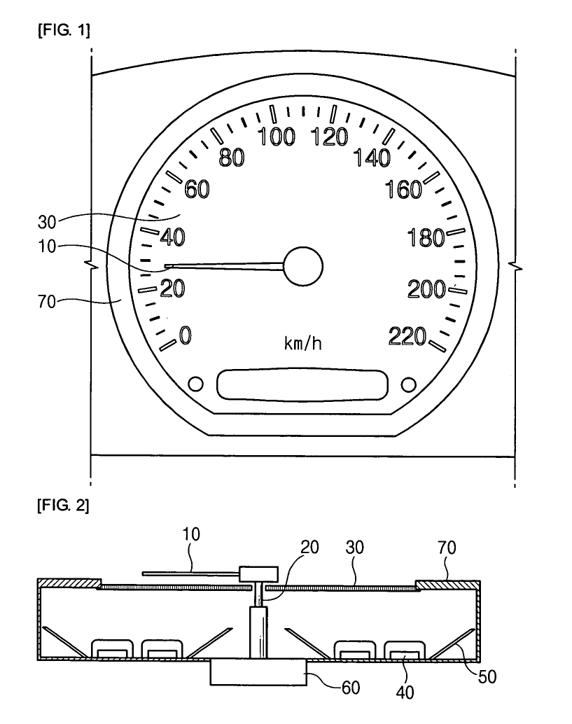

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, a preferred embodiment of the present invention will be described in detail with reference to the accompanying drawings.

FIG. 3 is a sectional view of a lighting device for display device used in vehicles according to an embodiment of the invention.

As shown in FIG. 3, the lighting device for display device according to the embodiment of the invention includes an indicator 10 provided with a rotating shaft 20; a graphic plate 30 disposed under the indicator 10 and having a through hole formed in the center thereof, into which the rotating shaft 20 is inserted; and an LED section 40 which is disposed under the graphic plate 30, generates light onto the graphic plate 30, and is provided with LED chips having a different color. Further, on the rear surface of the graphic plate 30, a motor 60 connected to the rotating shaft 20 of the indicator 10 is disposed so as to support and drive the indicator 10.

The LED section 40 according to the embodiment of the invention is composed of a combination of red, green, and blue LED chips, different from the one-color LED according to the related art.

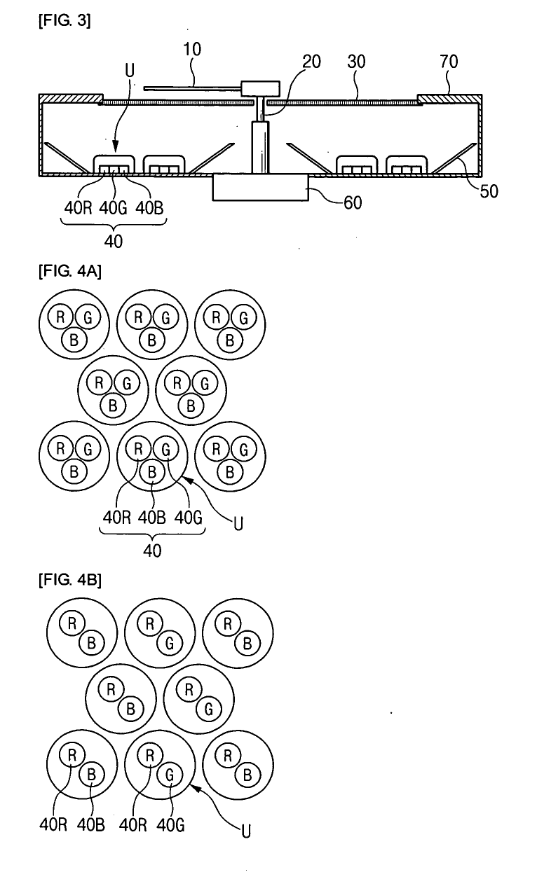

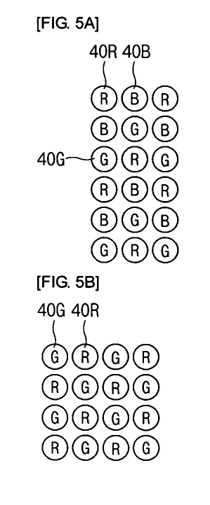

FIGS. 4 and 5 are plan views illustrating LED arrangements of the lighting device for display device according to the embodiment of the invention.

The LED section 40 is a lighting source used for the lighting device for display device according to the embodiment of the invention. As shown in FIG. 4A, the LED section 40 may be composed of at least one LED unit U which is composed of a combination of a red LED chip 40R, a green LED chip 40G, and a blue LED chip 40B.

Further, as shown in FIG. 4B, the LED section 40 may be composed of at least one LED unit U which is composed of a combination of two chips selected from a group consisting of the red LED chip 40R, the green LED chip 40G, and the blue LED chip 40B.

In other words, the LED section 40 may be provided with only one LED unit U or a plurality of LED units U, the LED unit U being composed of a combination of more than two chips selected from a group consisting of the red LED chip 40R, the green LED chip 40G, and the blue LED chip 40B.

In addition, the LED section 40 may be composed of LED chips having a different color instead of the above-described LED unit U. That is, the LED section 40 may be composed of more than two combinations of a group consisting of the red LED chip 40R, the green LED chip 40G, and the blue LED chip 40B. For example, more than one red LED chip 40R, more than one green LED chip 40G, and more than one blue LED chip 40B, respectively, are combined to compose the LED section 40, as shown in FIG. 5A.

As shown in FIG. 5B, the LED section 40 may be constructed by combining only two kinds of chips selected from a group consisting of the red LED chip 40R, the green LED chip 40G, and the blue LED chip 40B.

As described above, the LED section 40 according to the embodiment of the invention may be provided with one LED unit U or a plurality of LED units U, the LED unit U being composed of a combination of more than two chips selected from a group consisting of the red LED chip 40R, the green LED chip 40G, and the blue LED chip 40B. Alternately, the LED section 40 may be composed of more than two combinations of a group consisting of the red LED chip 40R, the green LED chip 40G, and the blue LED chip 40B. In such a manner, the LED section 40 is provided with multiple-color LEDs.

The LED section 40 composed of the LED units U or the respective LED chips can emit monochromatic light using one color among three colors of the red LED chip 40R, the green LED chip 40G, and the blue LED chip 40B. Further, the LED section 40 can emit various colors of light, including white color of light, by combining two kinds or three kinds of light.

According to the invention, a color of light emitted by the LED section 40 can be changed in accordance with the necessity, so that the lighting device for display device can illuminate various colors of light in accordance with a user's taste.

The lighting device according to the embodiment of the invention is constructed so that light generated from the LED section 40 fixed to the inside of the case 70 is directly illuminated onto the graphic plate 30. Here, a reflecting section 50 may be additionally included in order to improve a lighting effect. The reflecting section 50 reflects the light generated by the LED section 40 onto the graphic plate 30, thereby improving a lighting effect of the LED section 40.

The above-described lighting device for display device used in vehicles can be applied to a direct lighting method, in which the LED section 40 is installed so as to face the rear surface of the graphic plate 30 as shown in FIG. 3, thereby directly generating light onto the graphic plate 30. However, the lighting device can be also applied to an indirect lighting method, depending on a mounted position of the LED section 40.

In the lighting device for display device used in vehicles according to the invention, the LED section implementing more than two kinds of different colors is used as a lighting source. Therefore, one-color light can be emitted, or various colors of light including a white color can be emitted by combining red, green, and blue in accordance with a user's taste.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A lighting device for display device used in vehicles comprising:
an indicator provided with a rotating shaft;
a graphic plate disposed under the indicator and having a through hole formed in the center thereof, into which the rotating shaft is inserted; and
an LED section that is disposed under the graphic plate, generates light onto the graphic plate, and is provided with LED chips having different colors.

2. The fighting device according to claim 1,
wherein the LED section is composed of more than two combinations of a group consisting of a red LED chip, a green LED chip, and a blue LED chip.

3. The lighting device according to claim 1,
wherein the LED section is provided with at least one LED unit which is composed of a combination of more than two chips selected from a group consisting of a red LED chip, a green LED chip, and a blue LED chip.

4. The lighting device according to claim 1 further including
a reflecting section that reflects the light, generated by the LED section, onto the graphic plate.
